(19) United States
(12) Patent Application Publication
(10) Pub. No.: US 2020/0166147 A1
(43) Pub. Date: May 28, 2020

(54) NONRETURN VALVE

(71) Applicant: Centrotherm Systemtechnik GmbH, Brilon (DE)

(72) Inventor: Ralf Liese, Bestwig (DE)

(21) Appl. No.: 16/250,115

(22) Filed: Jan. 17, 2019

(30) Foreign Application Priority Data
Nov. 22, 2018 (EP) 18 207 877.4

(51) Int. Cl. F16K 15/06; F23L 11/00; F16K 31/12

(52) U.S. Cl. CPC F16K 15/06; F23L 11/005; F23J 2900/13004; F23J 2213/204; F16K 31/12

(57) ABSTRACT

A nonreturn valve for an exhaust pipe of a combustion device comprising including a tubular body, a floating body, a valve seat for the floating body disposed inside the tubular body, and a circumferential groove disposed radially inside the tubular body, wherein a radial inner circumferential wall portion is formed at least as a portion of a gas guide channel extending in the direction of the floating body and having a mouth circumferential edge. A tubular buoyancy body having the valve seat is disposed inside the circumferential groove and is formed to be movable in parallel to the radial inner circumferential wall portion between a buoyancy position in which the buoyancy body forms between itself and the mouth circumferential edge a circumferential passage gap connecting the circumferential groove to the gas guide channel and a blocking position closing the passage gap in an axial direction.

The object of the invention is a nonreturn valve for an exhaust pipe of a combustion device, the nonreturn valve having a tubular body which can be installed in a vertical portion of the exhaust pipe, a floating body, a valve seat disposed inside the tubular body for the floating body which is formed such that it is liftable from the valve seat by vertically upward steaming gas and a circumferential groove disposed radially inside the tubular body, delimited by a radial inner circumferential wall portion, a radial outer circumferential wall portion and a bottom wall portion, wherein the radial inner peripheral wall portion and the bottom wall portion are formed internally within the tubular body, and wherein the radial inner peripheral wall portion is formed at least as a portion of a gas guiding channel extending toward the floating body with a mouth circumferential edge.

### BACKGROUND OF THE INVENTION

Nonreturn valves of a known type are equipped, for example, with simple valve bodies or flaps which open wider or close depending on the gas pressure. In known systems, resetting is performed either by the weight force of the flaps or by means of resetting elements such as springs.

A nonreturn valve, for example, is described in DE 199 06 736 C1. In this document, a floating body with an upstream facing guide element in the form of a cone-like extension which is guided on the inner surface by guide webs is situated in a tubular body, and the guide webs being disposed essentially radially inwards on the inside of the tubular body.

Furthermore, a nonreturn valve is also known from DE 100 37 967 C1. In this nonreturn valve, the floating body, which can be lifted from the valve seat by upward flowing exhaust gas, has at least two subsections, each next-larger subsection forming an additional valve seat for the next-smaller subsection. Finally, a nonreturn valve of the type stated at the outset is known from EP 2 461 099 B1. In this nonreturn valve, the circumferential edge of the floating body protrudes radially beyond the radial inner circumferential wall portion and has an upstream facing axial extension which, when the at least one floating body rests on the valve seat, extends axially upstream into the circumferential groove. When the combustion device is at rest, the floating body rests on the valve seat. Liquid formed downstream of the floating body can be passed through the floating body's axial lip into the circumferential groove so that, when sufficient liquid has accumulated, the axial lip dips into the liquid. By dipping in the accumulated liquid, the axial lip of the floating body, together with the liquid, forms a liquid barrier in the manner of a fluid sealing seat. If such a nonreturn valve is used within a cascade of several combustion devices, a misfire of a combustion device due to the resulting pressure may, for example, cause the floating body to be pressed onto the valve seat and the prevailing pressure to push the accumulated liquid out of the circumferential groove, so that the blocking effect is eliminated by the floating body and is only restored when liquid has accumulated in the circumferential groove or has been refilled by a user. The elimination of the blocking effect carries the risk that exhaust gas may escape from the nonreturn valve and enter the installation room of a combustion device, which poses a serious hazard to persons staying in the installation room.

### SUMMARY OF THE INVENTION

The objective of the invention is creating a solution which provides an improved and particularly efficient nonreturn valve with a simple design and which also avoids the risk known from prior art.

In the case of a nonreturn valve of the type stated at the outset, the objective is achieved in accordance with the invention such that between the radial inner circumferential wall portion and the radial outer circumferential wall portion there is a tubular buoyancy body forming the valve seat, which is formed to be movable in parallel to the radial inner circumferential wall portion between a buoyancy position, in which the buoyancy body forms between itself and the mouth circumferential edge a circumferential passage gap connecting the circumferential groove to the gas guide channel, and a blocking position closing the passage gap in an axial direction.

Advantageous and practical configurations and further developments of the invention result from the subclaims.

The invention provides a nonreturn valve which is formed for very high blocking pressures. Known nonreturn valves of the prior art are designed for blocking pressures of 500 Pa to 1000 Pa, whereas the nonreturn valve according to the invention is designed for higher blocking pressures of up to 2500 Pa. In normal operation the floating body lifts off from the valve seat by vertically flowing exhaust gas so that exhaust gas from the combustion device can flow vertically through the nonreturn valve. In accordance with the invention, it is not necessary for the siphon-type circumferential groove interacting with the floating body to be filled with a fluid. If there is no fluid in the circumferential groove, the buoyancy body closes the passage gap, which connects the circumferential groove with the gas guide channel. If, however, the circumferential groove is filled with fluid, then the buoyancy body and the circumferential groove interact in the manner of a siphon and ensure that exhaust gas can only flow through the cross-section which is released by the floating body lifted off the valve seat. An excess of fluid in the circumferential groove is countered by the nonreturn valve according to the invention by channeling excess fluid through the passage gap into the gas guide channel. Consequently, there is no need to channel fluid from an opening connected to the outside area of the nonreturn valve, as is known from prior art.

Accordingly, the nonreturn valve according to the invention does not have an opening permanently connected to the outside area, so that with the nonreturn valve according to the invention the risk is avoided that an exhaust gas generated by the combustion device can escape from the nonreturn valve to the outside area in certain operating cases. For example, such a specific operating case is characterized by the fact that a sealing pressure acts temporarily against the normal direction of flow on the nonreturn valve, so that the effective blocking pressure presses the floating body against the valve seat. Thus, according to the invention, the blocking pressure also acts on the buoyancy body having the valve seat and being pushed against the normal flow direction within the circumferential groove. At a sufficiently high blocking pressure and/or empty circumferential groove, the floating body then pushes the buoyancy body towards the bottom wall portion in such a way that the buoyancy body rests on the mouth circumferential edge and closes the passage gap. In contrast to the prior art, this prevents, for example, in such an operating case that accumulated fluid, which is located in the circumferential groove, can be forced out of the circumferential groove and channeled through the gas guide channel. In other words, a prevailing blocking pressure prevents emptying of the circumferential groove filled with fluid. The buoyancy body, which is movably disposed in the circumferential groove, adapts to the level of fluid in the circumferential groove in accordance with the invention and also allows excess fluid to be channeled from the circumferential groove during normal operation. In particular, according to the invention, the buoyancy body adapts to various operating conditions and prevents accumulated fluid from being forced out of the circumferential groove in extreme operating conditions. In doing so, the buoyancy body provides an axially movable valve seat which, together with the buoyancy body, can move vertically in an axial direction parallel to the radial inner circumferential wall portion depending on the operating condition and/or the filling level of fluid in the circumferential groove and occupies a corresponding position. Since the nonreturn valve has no permanently open passage to the outside area of the nonreturn valve for the channeling of excess fluid located in the circumferential groove, no exhaust gas can escape from the nonreturn valve into the outer area. The invention provides a low-maintenance to maintenance-free nonreturn valve which retains its blocking function even when the circumferential groove has dried out due to its configuration and retains its functionality even without liquid inside the circumferential groove, which is particularly advantageous after long downtimes of the combustion device, such as in the summer months.

In the configuration of the nonreturn valve, the invention provides for a radially inwardly extending circumferential blocking extension to be formed on the inside of the buoyancy body, which, in the blocking position, is disposed resting on the mouth circumferential edge. The circumferential blocking extension ensures a defined blockade and closes the passage gap gas-tight so that in the blocking position no fluid can escape from the circumferential groove into the gas guide channel.

In order to limit the buoyancy movement of the buoyancy body, the configuration of the nonreturn valve in accordance with the invention further provides that at least one retaining arm is formed on the radial inner circumferential wall portion, which retaining arm extends radially inwards and blocks a movement of the buoyancy body out of the blocking position in the axial direction beyond the buoyancy position. In the other extreme position, namely the blocking position, the buoyancy body, as well as in the buoyancy position, is disposed at a distance from the bottom wall portion, wherein the distance between the buoyancy body and the bottom wall portion is greater in the buoyancy position than in the blocking position.

If the circumferential groove is completely filled with liquid or fluid, or if condensate is formed which causes the circumferential groove to overflow, accumulated liquid or condensate can also pass through the passage gap into the gas guide channel and be channeled. For this purpose, the invention further provides that a circumferential seat extending in the axial direction, which is the valve seat, is formed on the buoyancy body, wherein in the buoyancy position the circumferential seat between itself and the mouth circumferential edge forms the circumferential passage gap between the circumferential groove and the gas guide channel.

It is particularly advantageous and structurally favorable if, in the configuration of the invention, the buoyancy body has a buoyancy device which is formed to generate a force acting in the direction of the buoyancy position for the buoyancy body in the case of a fluid located in the circumferential groove. The fluid may be condensate accumulated in the circumferential groove or a liquid filled into the circumferential groove by a user.

The invention further provides for the buoyancy body to have a radial inner circumferential wall and a radial outer circumferential wall, the buoyancy device being a buoyancy chamber formed between the radial inner circumferential wall and the radial outer circumferential wall. The radial outer circumferential wall and the radial inner circumferential wall form an annular gap between them, which is open at the longitudinal end facing the bottom portion and closed at the other longitudinal end. The air present in the annular gap represents an air cushion and provides buoyancy as soon as the circumferential groove is filled with a corresponding quantity of fluid. As long as no fluid is present and thus no buoyancy acts on the buoyancy body, the buoyancy body is disposed in the blocking position.

In order to ensure that the accumulated fluid can only be channeled from the inside through the gas guide channel, the configuration of the invention provides that the radial outer circumferential wall portion extends beyond the radial inner circumferential wall portion when viewed in the axial direction from the bottom wall portion. The axial length of the radial outer circumferential wall portion is thus greater than the axial length of the radial inner circumferential wall portion.

For a guided axial movement of the floating body, the invention provides in further configuration that the floating body has an extension extending in the axial direction, a guide sleeve being formed inside the buoyancy body in which the floating body is guided movably in the axial direction. For flushing the circumferential groove and for channeling accumulated fluid, it is advantageous in the configuration of the invention if the radial outer circumferential wall portion is formed as an outer circumferential wall of the tubular body, wherein the outer circumferential wall has a closably formed through opening. Since the radial outer circumferential wall portion is also the outer circumferential wall of the tubular body, a very compact construction of the nonreturn valve can be achieved.

Finally, it is provided in the configuration of the invention that the floating body has at least one annular subsection and at least one plate-shaped subsection, each next-larger subsection forming an additional valve seat for the next-smaller subsection. Compared with known single-stage nonreturn valves, it is thus possible, in particular in combustion devices with large exhaust gas flows, to adapt the opening cross-section to small exhaust gas flows, such as occur, for example, in partial load operation, and to provide additional through openings for the very large quantities of exhaust gas produced in full load operation.

It should be understood that the features mentioned above and those still to be explained below can not only be used in the combination indicated, but also in other combinations or in a unique position, without departing from the scope of the present invention. The scope of the invention is only defined by the claims.

### BRIEF DESCRIPTION OF THE DRAWINGS

Further details, features and advantages of the object of the invention result from the following description in connection with the drawing, in which an exemplary and preferred exemplary embodiment of the invention is presented. In the drawing:

FIG. 1 shows a perspective view of a nonreturn valve according to the invention,

FIG. 2 shows a perspective illustration of the individual parts of the nonreturn valve according to invention from FIG. 1,

FIG. 3 shows a partially sectioned perspective view of the nonreturn valve according to the invention,

FIG. 4 shows a sectioned detail view of the nonreturn valve according to the invention, wherein a buoyancy body of the nonreturn valve is disposed in a blocking position,

FIG. 5 shows a detail view of the nonreturn valve according to the invention, wherein the buoyancy body of the nonreturn valve is disposed to be moved out of the blocking position,

FIG. 6 shows a perspective sectional view of a tubular body of the nonreturn valve according to the invention,

FIG. 7 shows a perspective sectional view of the buoyancy body of the nonreturn valve according to the invention,

FIG. 8 shows a partially sectioned front view of the nonreturn valve according to the invention for a normal operating status and a corresponding detailed view, and

FIG. 9 shows a partially sectioned front view of the nonreturn valve according to the invention for a blocked operating status and a corresponding detailed view.

### DETAILED DESCRIPTION

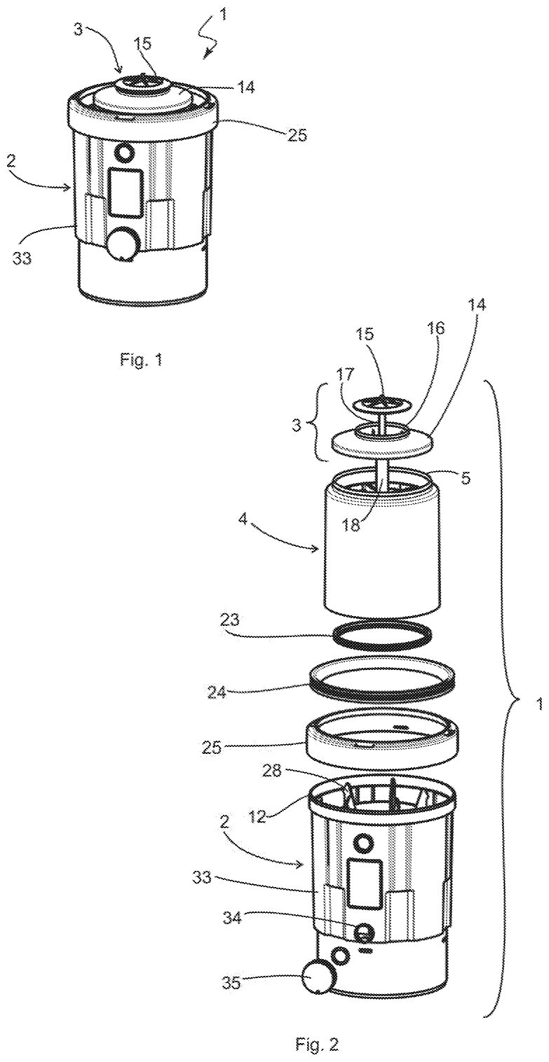

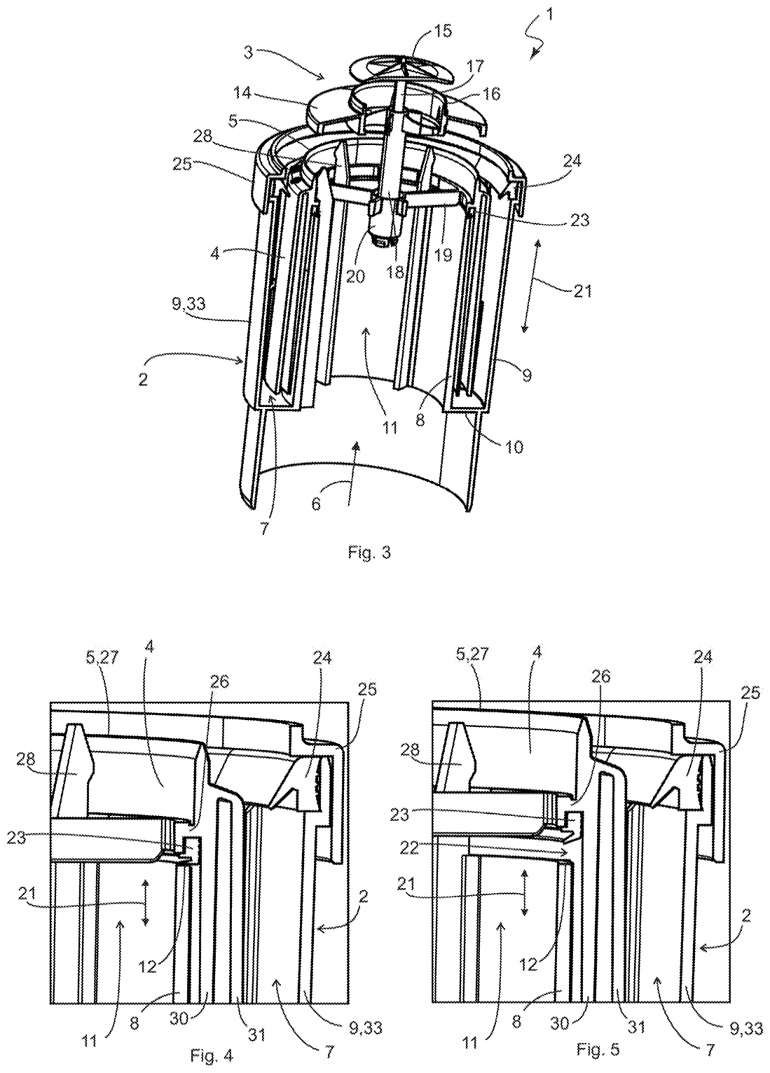

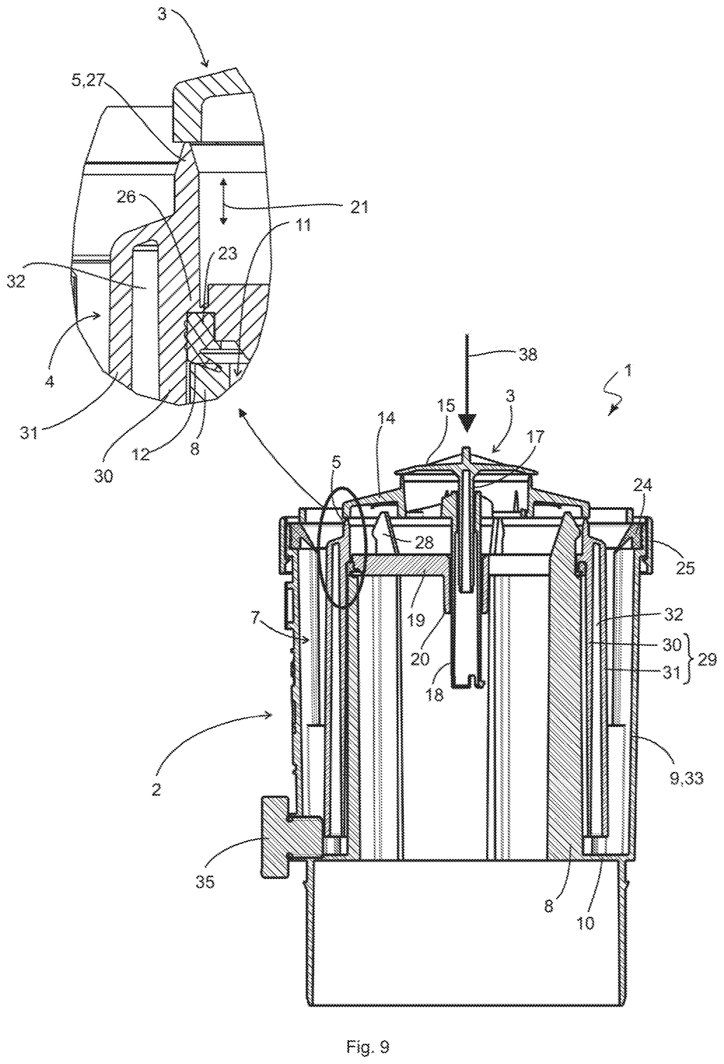

The following describes the nonreturn valve 1 according to the invention of an exhaust pipe of a combustion device with reference to FIGS. 1 to 9. The nonreturn valve 1 shown in FIG. 3 in a partially sectioned perspective view comprises, as essential components for the invention, a tubular body 2 which can be installed in a vertical portion of an exhaust pipe through which the flow passes from bottom to top, a floating body 3 which is movably disposed on the tubular body 2 and a buoyancy body 4 which is disposed inside the tubular body 2 and is tubular in shape. Inside the tubular body 2 a valve seat 5 is disposed, which is formed on the buoyancy body 4 and on which the floating body 3 rests in its closing position (see for example FIGS. 4 and 9). The floating body 3 can be lifted from the valve seat 5 downstream (see for example arrow 6 in FIG. 3 for the downstream direction) by an exhaust gas flowing vertically or from bottom to top. The term “downstream” refers to a direction in the flow direction of the exhaust gas, whereas the term “upstream” refers to the opposite direction and thus a direction opposite to the flow direction of the exhaust gas. The nonreturn valve 1 also has a circumferential groove 7 which is open downstream and is formed inside the tubular body 2. The radial inner circumferential groove 7 disposed in the tubular body 2 is delimited by a radial inner circumferential wall portion 8, a radial outer circumferential wall portion 9 and a bottom wall portion 10, wherein in the illustrated exemplary embodiment the radial inner circumferential wall portion 8 and the bottom wall portion 10 are formed by resting radially inward within the tubular body 2. In the exemplary embodiment shown, the radial inner circumferential wall portion 8, the radial outer circumferential wall portion 9 and the bottom wall portion 10 are also formed integrally with the tubular body 2, as can be seen for example from FIG. 6, which shows an illustration of the individual parts of the tubular body 2. As further shown in FIGS. 3 and 6, the radial inner circumferential wall portion 8 is formed at least as a portion of a gas guide channel 11 extending in the direction of the floating body 3, the gas guide channel 11 having a mouth circumferential edge 12 at one end side, the mouth of which is covered and closed by the floating body 3 in its closing position.

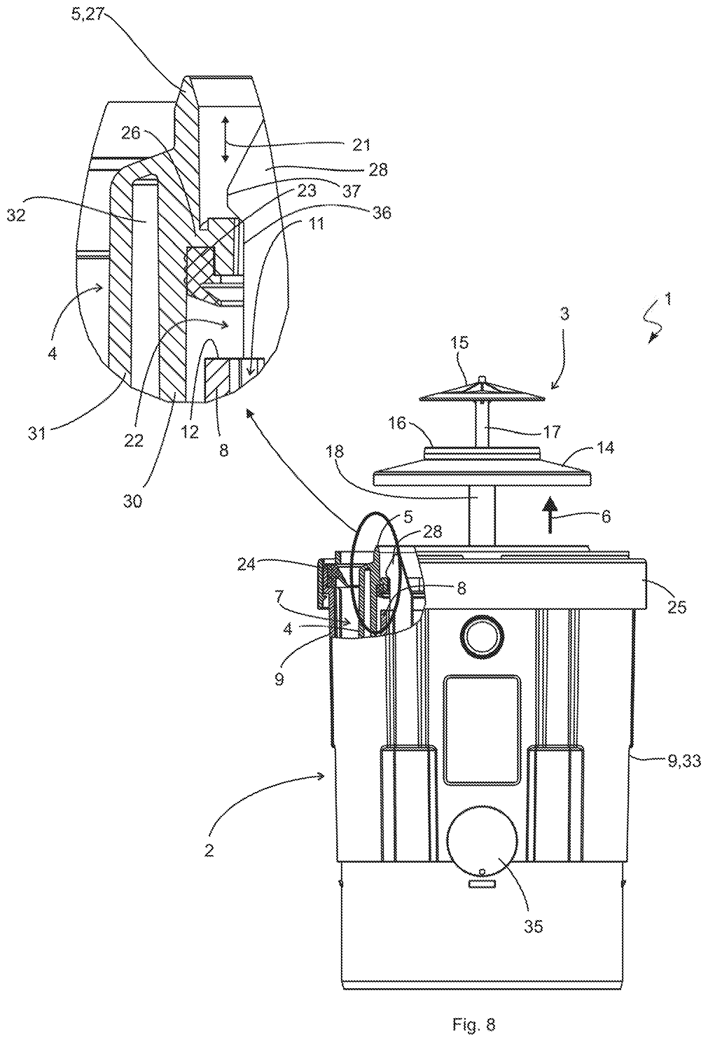

The floating body 3 comprises an outer subsection 14, which is ring-shaped, and an inner subsection 15, which is plate-shaped, as shown in FIGS. 2, 3 and below. In the closing position of floating body 3 (see FIGS. 1 and 9) the outer subsection 14 of floating body 3 rests on the valve seat 5. In addition, the outer subsection 14 forms an additional valve seat 16 (see for example FIG. 2) on which the inner subsection 15 rests in the closing position. If the associated combustion device is operated at partial load operation, for example, the inner or next-smaller subsection 15 lifts off from its additional valve seat 16 and partially releases the exhaust pipe. The position of the inner subsection 15 is adjusted to the amount of exhaust gas to be channeled. If the amount of exhaust gas increases further, as is the case with full-load operation of the combustion device, the outer subsection 14 of the floating body 3 also leaves its valve seat 5 and releases the maximum passage cross-section of the nonreturn valve 1, as shown, for example, in FIG. 8. From FIGS. 2 and 8 it is furthermore apparent that the inner subsection 15 of the floating body 3 carries an upstream, i.e. downwards, facing extension 17 which telescopically engages an extension 18 of the outer subsection 14 which is also facing upstream. The extension 18 of the outer subsection 14 is firmly connected to the buoyancy body 4 via radial arms 19 (see, for example, FIGS. 3 and 9) and a sleeve-shaped guide or guide sleeve 20. The sleeve-shaped extension 18 of the outer subsection 14 forms a guide for the cone-shaped extension 17 of the inner subsection 15 in its upper area. The extensions 17 and 18 each carry a stop at their lower end, which interacts with a complementary stop. This limits the upward movement of subsections 14 and 15 relative to the tubular body 2 and/or buoyancy body 4, respectively. In other words, the floating body 3 has the extension 18 extending in axial direction 21, wherein the guide sleeve 20 is formed radially inside the buoyancy body 4 and wherein the floating body 3 is movably guided in axial direction 21 by means of the guide sleeve 20. The nonreturn valve 1 with floating body 3 executed in two stages is suitable for high-capacity combustion devices with simultaneous control of the partial load area. As is appreciated by those skilled in the art, the floating body 3 is also executable in one part or with more than two parts.

As can also be seen from FIGS. 1 and 2, the nonreturn valve 1 in the illustrated exemplary embodiment also comprises an annular sealing element 23, which is fixed in a circumferential groove formed on the buoyancy body 4, and a sealing ring 24, which is inserted at one longitudinal end of the tubular body 2 and is fastened to the tubular body 2 by a socket ring 25, which can be detachably fastened to the tubular body 2. The sealing ring 24 is used to shield the circumferential groove 7 as much as possible vertically and to direct condensate flowing vertically upstream into the circumferential groove 7.

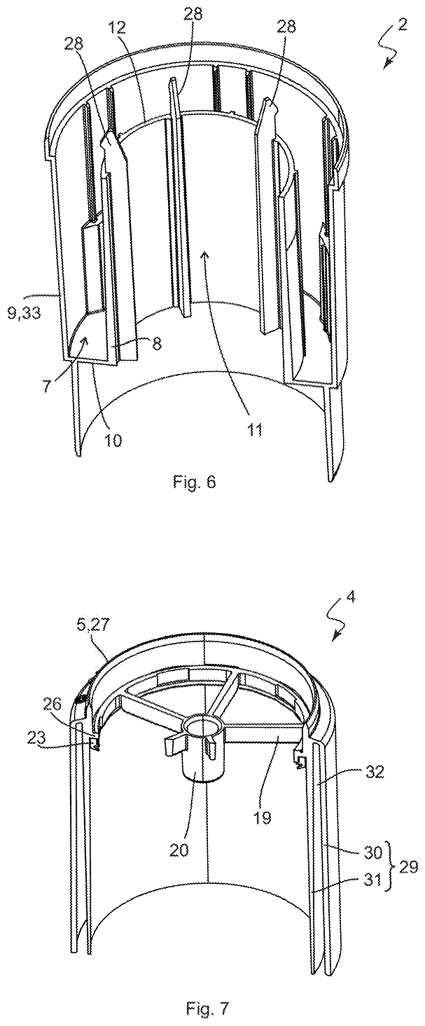

The tubularly formed buoyancy body 4 is shown as an illustration of the individual parts in FIG. 7. In the assembled state of the nonreturn valve 1, the buoyancy body 4 is disposed between the radial inner circumferential wall portion 8 and the radial outer circumferential wall portion 9 and at least partially within the circumferential groove 7. The tubular buoyancy body 4 is concentrically disposed around the radial inner circumferential wall portion 8, the buoyancy body 4 being movably formed between a buoyancy position (see for example FIGS. 5 and 8) and a blocking position (see for example FIGS. 4 and 9) in an axial direction 21 (see for example FIG. 3) parallel to the radial inner circumferential wall portion 8. The buoyancy body 4 is disposed at a distance from the bottom wall portion 10 both in the buoyancy position and in the locking position, wherein the distance between the buoyancy body 4 and the bottom wall portion 10 is greater in the buoyancy position than in the blocking position.

Retaining arms 28 guide the movement of the buoyancy body 4 between the buoyancy position and the blocking position, the retaining arms 28 being formed on the radial inner circumferential wall portion 8. The retaining arms 28 also block a movement of the buoyancy body 4 beyond the buoyancy position so that the buoyancy position defines the maximum downstream rise level of the buoyancy body 4.

In the buoyancy position, but also in intermediate positions until the blocking position is reached, the buoyancy body 4 forms a circumferential passage gap 22 between itself and the mouth circumferential edge 12 (see for example FIGS. 5 and 8). In doing so, the passage gap 22 connects the circumferential groove 7 with the gas guide channel 11, so that excess fluid can be channeled from the circumferential groove 7 into the gas guide channel 11. For this purpose, it is advisable that the radial outer circumferential wall portion 9 extends beyond the radial inner circumferential wall portion 8 when viewed in axial direction 21 from the bottom wall portion 10. In other words, the radial outer circumferential wall portion 9 has a greater longitudinal extent than the radial inner circumferential wall portion 8. In the blocking position, the buoyancy body 4 closes the passage gap 22 so that no fluid can be pushed out of the circumferential groove 7 and channeled via the passage gap 22.

To ensure the blocking effect, a circumferential blocking extension 26 is formed on the inside of the buoyancy body 4, which extends radially inwards. The circumferential blocking extension 26 is disposed over the sealing element 23 in the blocking position shown in FIGS. 4 and 9 on the mouth circumferential edge 12, so that no passage gap 22 is formed through which fluid or even gas flowing upstream from the circumferential groove 7 could pass into the gas guide channel 11. In addition, a circumferential seat 27 extending in axial direction 21 is formed on the buoyancy body 4. The circumferential seat 27 in the example shown is also the valve seat 5, so that the invention is characterized, among other things, by a valve seat 5 disposed movably in axial direction 21 within the tubular body 2.

The buoyancy position of the buoyancy body 4 shown in FIG. 8 represents the maximum achievable buoyancy height or ascent height for the buoyancy body 4. The retaining arms 28, which are formed on the radial inner circumferential wall portion 8, ensure that a movement of the buoyancy body 4 out of the blocking position in axial direction 21 beyond the buoyancy position is blocked, wherein in the buoyancy position (see for example FIG. 8) the circumferential blocking extension 26 rests against the hook-shaped retaining arms 28, which extend radially inwards, so that a further movement of the buoyancy body 4 beyond the buoyancy position is blocked. When the buoyancy body 4 is disposed in a position moved out of the blocking position or in the buoyancy position, the circumferential seat 27 between itself and the opening circumferential edge 12 forms the circumferential passage gap 22, through which, if necessary, fluid from the circumferential groove 7 can then pass into the gas guide channel 11 and is channeled via the gas guide channel 11.

In order to realize a movement of the buoyancy body 4 between the blocking position and the buoyancy position, the buoyancy body 4 has a buoyancy device 29. The buoyancy device 29 generates for the buoyancy body 4 in a fluid located in the circumferential groove 7 a force acting in the direction of the buoyancy position, so that the buoyancy body 4 in the circumferential groove 7 assumes a corresponding position in the axial direction 21 as a function of the filling level of the liquid within the circumferential groove 7 and/or as a function of the prevailing operating state. As can be seen from FIG. 7, the buoyancy body 4 has a radial inner circumferential wall 30 and a radial outer circumferential wall 31, each extending in the axial direction 21 and being connected to each other at their longitudinal ends lying downstream with respect to the installed state. The buoyancy device 29 is a buoyancy chamber 32 formed between the radial inner circumferential wall 30 and the radial outer circumferential wall 31 and containing air.

Although the functioning of the nonreturn valve 1 according to the invention can be understood from the above description, the two extreme positions of the nonreturn valve 1 with reference to FIGS. 4, 5, 8 and 9 are briefly described again below.

FIGS. 5 and 8 show a full-load operation of the combustion device in which the floating body 3 of the nonreturn valve 1 releases a maximum passage cross-section so that exhaust gas can flow downstream from the gas guide channel 11 (see arrow 6 in FIG. 8). Both subsections 14 and 15 of the floating body 3 are disposed so that they move at maximum capacity downstream the in axial direction 21. In addition, the buoyancy body 4 is also disposed to move at maximum capacity downstream in axial direction 21, wherein the retaining arms 28 retain the buoyancy body 4 in the buoyancy position and block a position of the buoyancy body 4 beyond the buoyancy position. At full-load operation the buoyancy body 4 is pulled into the buoyancy position by the floating body 3 downstream in the direction of arrow 6 in FIG. 8 when the gas flowing downstream lifts the floating body 3, regardless of the filling level of liquid in the circumferential groove 7 or whether the circumferential groove 7 is dry and without liquid. A guide surface 36 guides the downstream facing movement of the circumferential blocking extension 26 of the buoyancy body 4, such guide surface 36 being formed on each retaining arm 28 and extending to a retaining projection 37 formed at the end side of each retaining arm 28. In the buoyancy position, the circumferential blocking extension 26 of the buoyant body 4 abuts correspondingly against the radially outwardly projecting retaining projections 37 of the retaining arms 28 so that further movement of the buoyant body 4 downstream of the retaining arm 28 is blocked as shown in the detailed view of FIG. 8 for a retaining arm 28.

FIGS. 4 and 9 show a blocking operation for the nonreturn valve 1 according to the invention, in which a pressure acts upstream (see arrow 38 in FIG. 9), whereby the floating body 3 is disposed as pressed against the valve seat 5. The floating body 3 thus pushes the buoyancy body 4 upstream (see arrow 38 in FIG. 9) in such a way that the buoyancy body 4 closes the passage gap 22 by sealingly resting the circumferential blocking extension 26 on the mouth circumferential edge 12. This ensures that neither gas flowing upstream nor fluid from the circumferential groove 7 passes through the gas guide channel 11.

Finally, as can be seen from FIGS. 2 and 9, the radial outer circumferential wall portion 9 is formed as an outer circumferential wall 33 of the tubular body 2. In the outer circumferential wall 33 a closable through-opening 34 is formed, which serves as a drain for maintenance purposes when, for example, flushing the nonreturn valve 1 and which is closed with a knurled screw 35 in the example shown. In doing so, the passage opening 34 is connected to the circumferential groove 7.

The invention described above is of course not limited to the embodiment described and illustrated. It will be seen that numerous modifications can be made to the embodiment shown in the drawing, which are obvious to the person skilled in the art according to the intended application, without deviating from the scope of the invention. The invention includes everything that is contained in the description and/or depicted in the drawing, including anything that, in deviation from the concrete exemplary embodiment, is obvious to the person skilled in the art.

1. A nonreturn valve for an exhaust pipe of a combustion device, wherein the nonreturn valve has a tubular body which can be installed in a vertical portion of the exhaust pipe, a floating body, a valve seat disposed inside the tubular body for the floating body which is formed such that it is liftable from the valve seat by vertically upward steaming gas and a circumferential groove disposed radially inside the tubular body, defined by a radial inner circumferential wall portion, a radial outer circumferential wall portion and a bottom wall portion, wherein the radial inner circumferential wall portion and the bottom wall portion are formed internally within the tubular body, and wherein the radial inner circumferential wall portion is formed at least as a portion of a gas guiding channel extending toward the floating body with a mouth circumferential edge
wherein,
between the radial inner circumferential wall portion and the radial outer circumferential wall portion a tubularly formed buoyancy bodyforming the valve seat is disposed, which is formed to be movable in parallel to the radial inner circumferential wall portion between a buoyancy position in which the buoyancy body forms between itself and the mouth circumferential edge a circumferential passage gap connecting the circumferential groove to the gas guide channel and a blocking position closing the passage gap in an axial direction.

2. The nonreturn valve according to claim 1, wherein a radially inwardly extending circumferential blocking extension is formed on the inside of the buoyancy body, which, in the blocking position, is disposed resting on the mouth circumferential edge.

3. The nonreturn valve according to claim 2, wherein at least one retaining arm is formed on the radial inner circumferential wall portion, which retaining arm extends radially inwards and blocks a movement of the buoyancy body out of the blocking position in the axial direction beyond the buoyancy position.

4. The nonreturn valve according to claim 1, wherein a circumferential seat extending in the axial direction, which is the valve seat, is formed on the buoyancy body, wherein in the buoyancy position the circumferential seat between itself and the mouth circumferential edge forms the circumferential passage gap between the circumferential groove and the gas guide channel.

5. The nonreturn valve according to claim 1, wherein the buoyancy body has a buoyancy device which in the case of a fluid located in the circumferential groove is formed to generate a force acting in the direction of the buoyancy position for the buoyancy body.

6. The nonreturn valve according to claim 5, wherein the buoyancy body has a radial inner circumferential wall and a radial outer circumferential wall, wherein the buoyancy device is formed as a buoyancy chamber formed between the radial inner circumferential wall and the radial outer circumferential wall.

7. The nonreturn valve according to claim 1, wherein the radial outer circumferential wall portion extends beyond the radial inner circumferential wall portion when viewed in axial direction from the bottom wall portion.

8. The nonreturn valve according to claim 1, wherein the floating body has an extension extending in the axial direction, wherein a guide sleeve is formed inside the buoyancy body, in which the floating body is guided movably in the axial direction.

9. The nonreturn valve according to claim 1, wherein the radial outer circumferential wall portion f is formed as an outer circumferential wall of the tubular body, wherein the outer circumferential wall has a closably formed through opening.

10. The nonreturn valve according to claim 1, wherein the floating body has at least one annular subsection and at least one plate-shaped subsection, wherein each next-larger subsection forms an additional valve seat for the next-smaller subsection.
